(19) United States
(12) Patent Application Publication
(10) Pub. No.: US 2018/0107317 A1
(43) Pub. Date: Apr. 19, 2018

(54) DEVICE AND METHOD FOR DRIVING A DISPLAY PANEL

(71) Applicant: SYNAPTICS INCORPORATED, San Jose, CA (US)

(72) Inventors: Nobukazu TANAKA, Tokyo (JP); Takayuki NOTO, Tokyo (JP); Masaaki SHIOMURA, Tokyo (JP)

(21) Appl. No.: 15/782,508

(22) Filed: Oct. 12, 2017

(30) Foreign Application Priority Data
Oct. 14, 2016 (JP) 2016-202870

(51) Int. Cl. G06F 3/041; G06F 3/044; G09G 3/20

(52) U.S. Cl. CPC G06F 3/0412; G06F 3/044; G09G 3/3677; G09G 3/2092; G09G 2330/028; G06F 3/0416

(57) ABSTRACT

A display driver includes: a plurality of source output terminals configured to be connected to a plurality of source input terminals of a display panel; a source driver circuitry configured to generate source signals to the source input terminals; a plurality of interconnections connected to a capacitance detection circuitry for touch sensing in a sensing region of the display panel, and a selector. The selector is configured to selectively connect the source output terminals to the source driver circuitry and the interconnections.

### CROSS REFERENCE

This application claims priority of Japanese Patent Application No. 2016-202870, filed on Oct. 14, 2016, the disclosure of which is incorporated herein by reference.

### TECHNICAL FIELD

The disclosed technology relates to a display device adapted for touch sensing.

### BACKGROUND ART

Recent display devices are often configured to detect an input object such as user fingers and styli on a display panel. A display device is, for example, used in a device configured to operate in response to user input such as a smart phone and a tablet.

One technique may utilize capacitive touch sensing to detect an input object based on capacitance of a sensor electrode which varies as the input object approaches the sensor electrode. The capacitive touch sensing may include self-capacitance touch sensing which detects changes in the capacitive coupling between sensor electrodes and an input object and mutual capacitance touch sensing which detects changes in capacitance between transmitter sensing electrodes and receiver sensing electrodes.

In one configuration of a display device, a touch panel comprises electrodes for capacitive touch sensing arranged on the display panel.

In another configuration of a display device, touch sensing electrodes are embedded in the display panel. In a liquid crystal display panel, for example, common electrodes (or counter electrodes) may be used as the touch sensing electrodes. This configuration often has connection terminals respectively connected to the touch sensing electrodes in the display panel.

The display driver may comprise a source driver circuitry for driving source lines of the display panel. The source driver circuitry may be integrated with a touch sensing controller configured for the capacitive touch sensing in one or more chips. The external connection terminals may be connected to output pads of the source driver circuitry and the touch sensing controller. An increase in the number of the external connection terminals in the display panel may cause an increase in the number of the output pads.

As an art which may be related to the present disclosure, Japanese Patent Application Publication No. 2015-225381 discloses a touch sense circuitry adapted to both of the self-capacitance touch sensing and the mutual capacitance touch sensing.

### SUMMARY

In one embodiment a display driver includes: a plurality of source output terminals configured to be connected to a plurality of source input terminals of a display panel; a source driver circuitry configured to generate source signals to the source input terminals; a plurality of interconnections connected to a capacitance detection circuitry for touch sensing in a sensing region of the display panel; and a selector. The selector is configured to selectively connect the source output terminals the source driver circuitry and the interconnections.

In another embodiment, a display device includes: a display panel including a plurality of source lines and a plurality of source input terminals; a source driver circuitry configured to supply to a plurality of source input terminals source signals to be supplied to the plurality of source lines; a capacitance detection circuitry for touch sensing in a sensing region of the display panel; and a selector. The selector is configured to selectively connect the source input terminals to the source driver circuitry and the capacitance detection circuitry.

In still another embodiment, a display panel includes: a plurality of source lines, a plurality of source input terminals configured to receive source signals to be supplied from a display driver to the plurality of source lines; a plurality of common electrodes; a first switch connected between each of the plurality of common electrodes and at least one associated source input terminal of a plurality of source input terminals, the associated source input terminal being associated with each of the plurality of common electrodes.

### BRIEF DESCRIPTION OF THE DRAWINGS

FIG. 1 is a block diagram schematically illustrating the configuration of a display device in one embodiment;

FIG. 2 is a section view schematically illustrating the configuration of a display panel in one embodiment;

FIG. 3 is a plan view schematically illustrating the configuration of the display panel;

FIG. 4 illustrates details of the configuration of the display device in one embodiment;

FIG. 5 illustrates details of the configuration of the display panel in one embodiment;

FIG. 6 illustrates the configuration of the display device in another embodiment;

FIG. 7 illustrates the configuration of a display device in still another embodiment;

FIG. 8 illustrates the configuration of a display device in still another embodiment;

FIG. 9 illustrates the configuration of a display device in still another embodiment;

FIG. 10 illustrates the configuration of a display device in still another embodiment;

FIG. 11 illustrates details of the configuration of a display panel of the display device illustrated in FIG. 10;

FIG. 12 illustrates the configuration of a display device in still another embodiment;

FIG. 13 illustrates details of the configuration of a display panel of the display device illustrated in FIG. 12;

FIG. 14 illustrates the configuration of a display panel in still another embodiment;

FIG. 15 illustrates the configuration of a display device including the display panel illustrated in FIG. 14;

FIG. 16 illustrates the configuration of a display device in still another embodiment;

FIG. 17 illustrates details of the configuration of a display panel of the display device illustrated in FIG. 16;

FIG. 18 illustrates the configuration of a display device in still another embodiment; and

FIG. 19 illustrates details of the configuration of a display panel of the display device illustrated in FIG. 18.

### DETAILED DESCRIPTION

Various embodiments will be described below with reference to the attached drawings. In the following, same or similar components may be denoted by the same or corresponding reference numerals. It will be also appreciated that for simplicity and clarity of illustration, elements in the figures have not necessary drawn to scale. For example, the dimensions of some of the elements are exaggerated relative to other elements.

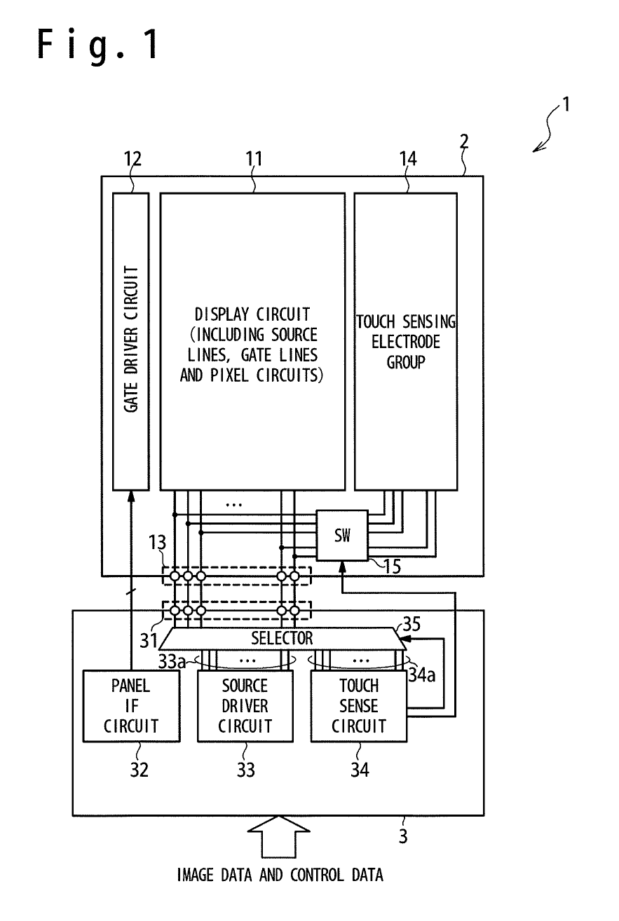

FIG. 1 is a block diagram schematically illustrating the configuration of a display device 1 in one embodiment. It should be noted that FIG. 1 illustrates a basic concept of the configuration of the display device 1 and the arrangement of the components of the display device 1 illustrated in FIG. 1 does not necessarily coincide with the spatial arrangement of the components in an actual implementation.

In the present embodiment, the display device 1 includes a display panel 2 and a display driver 3. Examples of the display panel 2 may include a liquid crystal display panel and an OLED (organic light emitting diode) display panel.

The display panel 2 comprises display circuitry 11 and gate driver circuitry 12. The display circuitry 11 includes a set of circuits used to display an image, for example, a plurality of source lines, a plurality of gate lines, a plurality of pixel circuits each disposed at an intersection of the corresponding source line and gate line. The pixel circuits may be variously configured. In a liquid crystal display panel, a pixel circuit includes, for example, a select transistor formed as a TFT (thin film transistor), a pixel electrode and a hold capacitor. In an OLED display panel, on the other hand, a pixel circuit includes, for example, a select transistor formed as a TFT (thin film transistor), a drive transistor, a hold capacitor and an organic light emitting diode element. The display panel 2 includes source input terminals 13. The source input terminals 13 are external input terminals used to receive source signals from the display driver 3. The source signals supplied to the source input terminals 13 are delivered to the respective pixel circuits via the source lines of the display circuitry 11 and an image is thereby displayed in the region in which the display circuitry 11 of the display panel 2 is formed.

The display panel 2 comprises a touch sensing electrode group 14 and a switch circuitry 15, for sensing an input object. As described later in detail, the static capacitance of the respective touch sensing electrodes included in the touch sensing electrode group 14 is detected and the position of the input object is sensed on the basis of the capacitance of the touch sensing electrodes. The switch circuitry 15 is responsive to a control signal received from the display driver 3 for electrically connecting and disconnecting the source input terminals 13 and the touch sensing electrode group 14. In detail, the switch circuitry 15 electrically disconnects the touch sensing electrode group 14 from the source input terminals 13 in a display drive operation to drive the respective pixel circuits in the display circuitry 11 and electrically connects the touch sensing electrode group 14 to the source input terminals 13 in a touch sensing operation to sense an input object. As described later in detail, this configuration, which provides an access to the touch sensing electrode group 14 via the source input terminals 13, effectively reduces the number of external input terminals disposed on the display panel 2.

The display driver 3 drives the display panel 2 in response to externally-received image data and control data (from a host, for example). The display driver 3 includes source output terminals 31 connected to the source input terminals 13 of the display panel 2 and is configured to output source signals to be supplied to the source lines of the display circuitry 11 of the display panel 2 from the source output terminals 31. Additionally, the display driver 3 is configured to output gate control signals controlling the gate driver circuitry 12 and switch control signals controlling the switch circuitry 15.

Furthermore, the display driver 3 is configured to detect the capacitance of the respective touch sensing electrodes included in the touch sensing electrode group 14 and sense an input object on the basis of the detected capacitance. In other words, the display driver 3 also operates as a touch controller which senses an input object. This type of display driver is often referred to as touch-controller-embedded display driver.

In detail, the display driver 3 includes a panel interface circuitry 32, a source driver circuitry 33, a touch sense circuitry 34, a selector 35 and a controller 37.

The panel interface circuitry 32 generates the gate control signals to be supplied to the gate driver circuitry 12.

The source driver circuitry 33 provides the source signals to the respective source lines of the display circuitry 11 of the display panel 2. The outputs of the source driver circuitry 33 are connected to the selector 35 via interconnections 33a.

The touch sense circuitry 34 includes circuitry performing a touch sensing operation to sense an input object. The touch sense circuitry 34 includes capacitance detection circuitry configured to detect the capacitance of conductors connected to the inputs thereof and the inputs of the touch sense circuitry 34 (that is, the inputs of the capacitance detection circuitry) are connected to the selector 35 via interconnections 34a. When the touch sensing electrode group 14 is connected to the inputs of the touch sense circuitry 34 via the switch circuitry 15 and the selector 35, the touch sense circuitry 34 detects the capacitance of the respective touch sensing electrodes of the touch sensing electrode group 14 with the capacitance detection circuitry, and generates the capacitance data indicative of the detected capacitance. The touch sense circuitry 34 senses an input object on the basis of the capacitance data (that is, the capacitance detected by the capacitance detection circuitry). Additionally, the touch sense circuitry 34 generates control signals controlling the operation in the touch sensing and supplies the control signals to the switch circuitry 15 of the display panel 2 and the selector 35 of the display driver 3.

The selector 35 is configured to selectively connect the source output terminals 31 to the outputs of the source driver circuitry 33 or the inputs of the touch sense circuitry 34 (that is, selectively connect the source output terminals 31 to the interconnections 33a or 34a) in response to the control signals received from the touch sense circuitry 34.

The display device 1 illustrated in FIG. 1 operates as follows: When a display drive operation is performed to drive the respective pixel circuits in the display circuitry 11, the switch circuitry 15 electrically disconnects the touch sensing electrode group 14 from the source input terminals 13 in the display panel 2 and the selector 35 electrically connects the outputs of the source driver circuitry 33 to the source output terminals 31 in the display driver 3. The source driver circuitry 33 supplies source signals to the source lines of the display circuitry 11 via the selector 35 and the source output terminals 31, and thereby drives the respective pixel circuits in the display circuitry 11.

When a touch sensing operation is performed, on the other hand, the switch circuitry 15 electrically connects the touch sensing electrode group 14 to the source input terminals 13 in the display panel 2 and the selector 35 electrically connects the source output terminals 31 to the inputs of the touch sense circuitry 34 in the display driver 3. This allows connecting the touch sensing electrode group 14 to the inputs of the touch sense circuitry 34 via the switch circuitry 15 and the selector 35. The touch sense circuitry 34 detects the capacitance of the respective touch sensing electrodes included in the touch sensing electrode group 14, and performs touch sensing, which may include, for example, sensing of the position where an input object such as human fingers and styli is placed into contact with the display panel 2, on the basis of the capacitance detected by the touch sense circuitry 34.

The display device 1 of the present embodiment, in which the touch sensing electrode group 14 included in the display panel 2 is connectable to any of the touch sense circuitry 34 via the switch circuitry 15, the source input terminals 13 and the selector 35, eliminates the need for providing external connection terminals dedicated to connect the touch sensing electrode group 14 to the touch sense circuitry 34. This allows reducing the number of external connection terminals disposed on the display panel 2.

In the following, a description is given of further specific configuration examples of the display device 1. In the configuration examples described below, a liquid crystal display panel incorporating touch sensing electrodes is used as the display panel 2. A variety of configuration examples of the display device 1 will be described in the following.

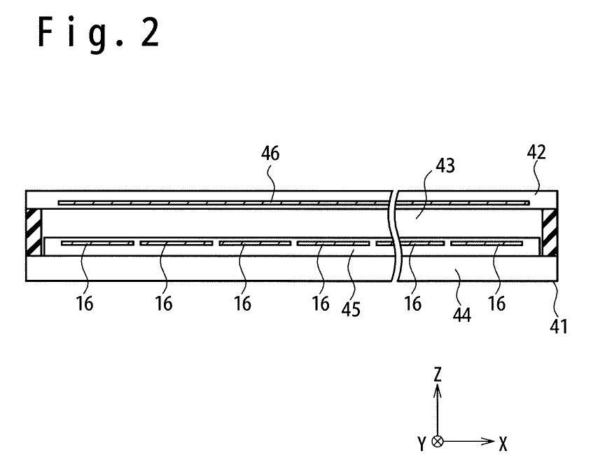

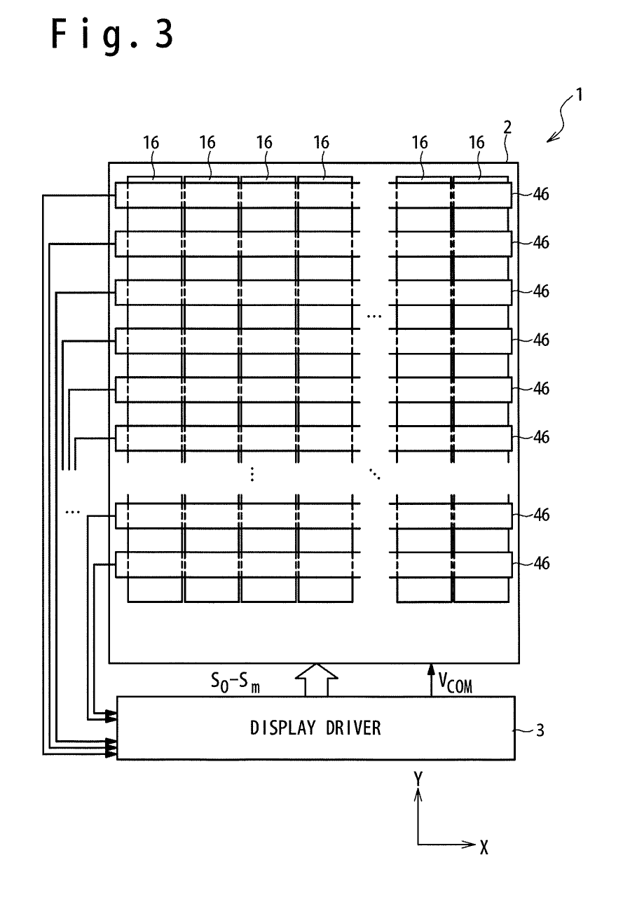

FIG. 2 is a section view schematically illustrating the configuration of the display panel 2 in one embodiment, and FIG. 3 is a plan view schematically illustrating the configuration of the display panel 2. In the following disclosure, an XYZ Cartesian coordinate system is introduced. The X axis direction is defined as the direction in which the gate lines of the display panel 2 are extended, the Y axis direction is defined as the direction in which the source lines are extended, and the Z axis direction is defined as the thickness direction of the display panel 2.

Referring to FIG. 2, the display panel 2 includes a TFT (thin film transistor) substrate 41 and a counter substrate 42. The counter substrate 42 is arranged so that the TFT substrate 41 and the counter substrate 42 are opposed to each other, and liquid crystal 43 is filled between the TFT substrate 41 and the counter substrate 42.

The TFT substrate 41 includes a glass substrate 44 and a semiconductor circuitry 45 integrated on the glass substrate 44. The semiconductor circuitry 45 incorporates the above-described display circuitry 11, gate driver circuitry 12 and switch circuitry 15 (not illustrated in FIGS. 2 and 3). Additionally, the semiconductor circuitry 45 includes a plurality of common electrodes 16 in the present embodiment. As illustrated in FIG. 3, the common electrodes 16 are arrayed in the X axis direction, and each common electrode 16 is extended in the Y axis direction. It should be noted that the configuration in which common electrodes are formed in a TFT substrate is well known in the art as disclosed in International Publication No. WO 2013/100088, for example.

In the present embodiment, the counter substrate 42 includes a plurality of Y sensing electrodes 46. As illustrated in FIG. 3, the Y sensing electrodes 46 are each extended in the X axis direction and arrayed in the Y axis direction. The Y sensing electrodes 46 are used to sense the position of an input object in the Y axis direction. The display driver 3 is configured to detect the capacitance of the respective Y sensing electrodes 46 and sense the position of an input object, on the basis of the detected capacitance.

The common electrodes 16 are used not only to drive the liquid crystal 43 by the respective pixel circuits, but also to sense the position of an input object. In other words, the common electrodes 16 are also used as the touch sensing electrodes of the touch sensing electrode group 14 in the configuration illustrated in FIG. 1. The display driver 3 is configured to detect the capacitance of the respective common electrodes 16 and sense the position of an input object, on the basis of the detected capacitance, as well as supply a common voltage V_{COM} to the common electrodes 16. The counter substrate 42 may include additional components, such as a color filter and a polarizer plate, which are not illustrated in FIGS. 2 and 3.

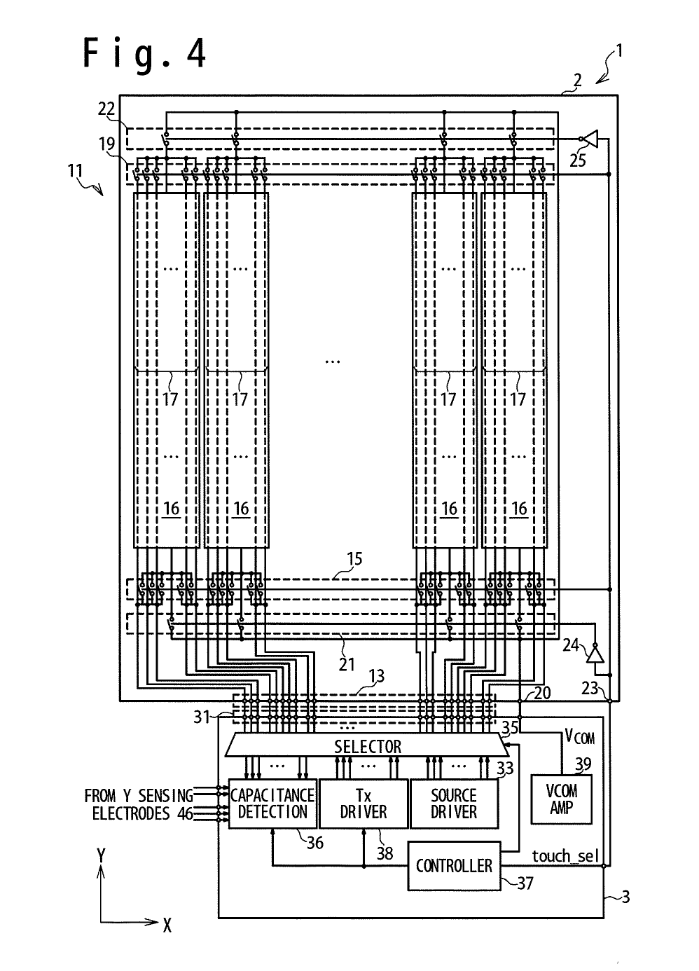

FIG. 4 is an illustration illustrating details of the configuration of the display device 1 in the present embodiment.

As described above, the display panel 2 incorporates the display circuitry 11, the gate driver circuitry 12 (not illustrated in FIG. 4) and the switch circuitry 15. Out of the components included in the display circuitry 11, only the common electrodes 16 and the source lines 17 are illustrated in FIG. 4. The source lines 17 are positioned under the common electrodes 16 (that is, between the common electrodes 16 and the glass substrate 44), and therefore the portions of the source lines 17 positioned behind the common electrodes 16 are indicated with broken lines.

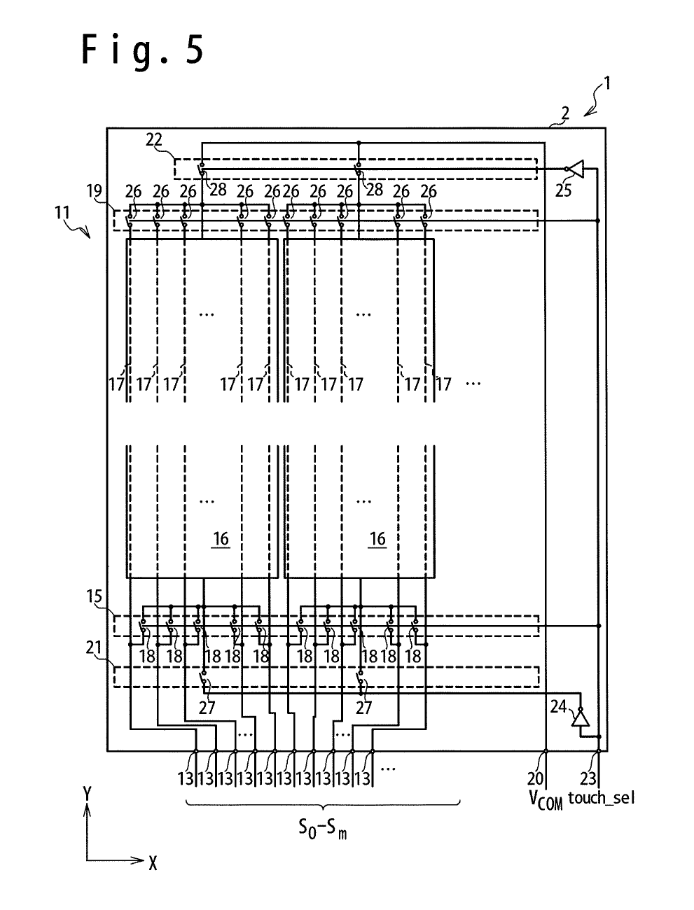

FIG. 5 is an enlarged view of the display panel 2 illustrated in FIG. 4. In the configuration illustrated in FIG. 4, the source lines 17 are one-to-one associated with the source input terminals 13 and connected to the source input terminals 13, respectively. The switch circuitry 15 includes switches 18 connected to the source input terminals 13, respectively. In the present embodiment, each common electrode 16 is associated with a plurality of source lines 17 (that is, a plurality of source lines 17 are arranged below each common electrode 16), and each common electrode 16 is connected to the source input terminals 13 connected to the associated source lines 17 via switches 18. The switch circuitry 15 is positioned near the display driver 3 (that is, between the display driver 3 and the common electrodes 16) and the respective switches 18 of the switch circuitry 15 are connected to the ends of the associated source lines 17 positioned close to the source input terminals 13.

The display panel 2 further includes a switch circuitry 19, a VCOM input terminal (common voltage input terminal) 20, VCOM switch circuitry 21 and VCOM switch circuitry 22, a switch control terminal 23 and inverters 24 and 25.

The switch circuitry 19 has the function of electrically connecting each common electrode 16 to the source lines 17 associated therewith. The switch circuitry 19 is positioned away from the display driver 3 (at a position opposite to the display driver 3 across the common electrodes 16). As illustrated in FIG. 5, the switch circuitry 19 includes switches 26 connected between each common electrode 16 and the source lines 17 associated therewith. Each switch 26 of the switch circuitry 19 is connected at the end of the associated source line 17 positioned away from the associated source input terminal 13.

The VCOM input terminal 20 and the VCOM switch circuitry 21 and VCOM switch circuitry 22 have the function of supplying the common voltage V_{COM} received from the display driver 3 to the respective common electrodes 16. In detail, the VCOM input terminal 20 receives the common voltage V_{COM} from the display driver 3. The VCOM switch circuitry 21 and VCOM switch circuitry 22 electrically connect or disconnect the VCOM input terminal 20 to or from the respective common electrodes 16. The VCOM switch circuit 21 includes switches 27 connected between the VCOM input terminal 20 and the ends of the respective common electrodes 16 in the −Y direction and the VCOM switch circuit 22 includes switches 28 connected between the VCOM input terminal 20 and the ends of the respective common electrodes 16 in the +Y direction. The VCOM switch circuit 21 is positioned near the display driver 3 (between the display driver 3 and the common electrodes 16), while the VCOM switch circuit 22 is positioned away from the display driver 3 (at a position opposite to the display driver 3 across the common electrodes 16).

The switch control terminal 23 and the inverters 24 and 25 are used to control the switch circuitry 15 and the switch circuitry 19 and the VCOM switch circuitry 21 and VCOM switch circuitry 22. The switch control terminal 23 receives a switch control signal touch_sel from the display driver 3 and supplies the switch control signal touch_sel to the switch circuitry 15 and the switch circuitry 19. The inverters 24 and 25 generate inverted signals of the switch control signal touch_sel and supply the inverted signals to the switches 27 and 28 of the VCOM switch circuitry 21 and VCOM switch circuitry 22. The switches 18 and 26 of the switch circuitry 15 and the switch circuitry 19 and the switches 27 and 28 of the VCOM switch circuitry 21 and VCOM switch circuitry 22 are exclusively turned on in response to the switch control signal touch_sel. In detail, when the switch control signal touch_sel is asserted, the switches 18 and 26 of the switch circuits 15 and 19 are turned on and the switches 27 of the VCOM switch circuitry 21 and the switches 28 of the VCOM switch circuitry 22 are turned off. When the switch control signal touch_sel is negated, on the other hand, the switches 18 of the switch circuitry 15 and the switches 26 of the switch circuitry 19 are turned off and the switches of the VCOM switch circuitry 21 and the switches 28 of the VCOM switch circuitry 22 are turned on.

Referring back to FIG. 4, the display driver 3 incorporates the source output terminals 31, the panel interface circuitry 32, the source driver circuitry 33 and the selector 35. It should be noted that the panel interface circuitry 32 is not illustrated in FIG. 4. The display driver 3 further includes capacitance detection circuitry 36 and a controller 37. The source output terminals 31, the panel interface circuitry 32, the source driver circuitry 33, the selector 35, the capacitance detection circuitry 36 and the controller 37 are monolithically integrated (that is, within the same semiconductor chip).

The capacitance detection circuitry 36 and the controller 37 are components corresponding to the touch sense circuitry 34 illustrated in FIG. 1. The inputs of the capacitance detection circuitry 36 are connected to the selector 35. In the configuration illustrated in FIG. 4, the capacitance detection circuitry 36 also has inputs connected to the Y sensing electrodes 46. The capacitance detection circuitry 36 is configured to generate capacitance data indicative of the capacitance of conductors connected to the inputs of the capacitance detection circuitry 36. When the common electrodes 16 are connected to the inputs of the capacitance detection circuitry 36 via the selector 35, the capacitance detection circuitry 36 detects the capacitance of the common electrodes 16. The capacitance detection circuitry 36 is also configured to detect the capacitance of the Y sensing electrodes 46, and the capacitance between the common electrodes 16 and the Y sensing electrodes 46. The controller 37 controls the operation of the display driver 3, more specifically, the drive operation of the source lines 17 of the display panel 2 and the touch sensing operation. In a touch sensing operation, the controller 37 calculates the position at which an object is placed into contact with the display panel 2, on the basis of the capacitance data received from the capacitance detection circuitry 36 (that is, on the basis of the capacitance detected by the capacitance detection circuitry 36).

Additionally, the display driver 3 includes a transmitter driver 38 and a VCOM amplifier 39 in the configuration illustrated in FIG. 4. The transmitter driver 38 is used to sense an input object with mutual capacitance touch sensing. When an input object is sensed with mutual capacitance touch sensing, the common electrodes 16 are used as transmitter electrodes and the Y sensing electrodes 46 are used as receiver electrodes. The transmitter driver 38 drives the common electrodes 16, which are used as transmitter electrodes, when an input object is sensed with mutual capacitance touch sensing. The VCOM amplifier 39 operates as a common voltage generator circuitry which generates the common voltage V_{COM} and supplies the common voltage V_{COM} to the VCOM input terminal 20 of the display panel 2.

It should be noted that, in the configuration illustrated in FIG. 4, the selector 35 performs an operation of selectively connect the source output terminals 31 to any of the three connection destinations: the source driver circuitry 33, the capacitance detection circuitry 36 and the transmitter driver 38.

Next, a description is given of the operation of the display device 1 configured as illustrated in FIGS. 4 and 5. The display device 1 illustrated in FIG. 4 is adapted to three operations: (1) a display drive operation to drive the respective pixel circuits of the display circuitry 11, (2) a touch sensing operation through self-capacitance touch sensing and (3) a touch sensing operation through mutual capacitance touch sensing. In the following, a description is given of these operations.

When the drive operation is performed, the display driver 3 of the display device 1 operates as follows: The controller 37 of the display driver 3 negates the switch control signal touch_sel. In response to the negation of the switch control signal touch_sel, the switches 27 of the VCOM switch circuitry 21 and the switches 28 of the VCOM switch circuitry 22 are turned on and the switches 18 of the switch circuitry 15 and the switches 26 of the switch circuitry 19 are turned off. This allows connecting the respective common electrodes 16 to the VCOM amplifier 39. The VCOM amplifier 39 supplies the common voltage V_{COM} to the respective common electrodes 16. Meanwhile, the selector 35 connects the source output terminals 31 to the outputs of the source driver circuitry 33 under the control of the controller 37. This allows connecting the respective source lines 17 of the display panel 2 to the outputs of the source driver circuitry 33. The source driver circuitry 33 supplies the source signals to the respective source lines 17 of the display panel 2 from the source output terminals 31 via the selector 35. This operation allows driving the respective pixel circuits of the display circuitry 11.

When self-capacitance touch sensing is performed, the display driver 3 operates as follows: The controller 37 of the display driver 3 asserts the switch control signal touch_sel. In response to the assertion of the switch control signal touch_sel, the switches 18 of the switch circuitry 15 and the switches 26 of the switch circuitry 19 are turned on and the switches 27 of the VCOM switch circuitry 21 and the switches 28 of the VCOM switch circuitry 22 are turned off. This allows connecting the respective common electrodes 16 to the source input terminals 13 in the display panel 2. Meanwhile, the selector 35 connects the source output terminals 31 to the inputs of the capacitance detection circuitry 36 under the control of the controller 37. This allows connecting the respective common electrodes 16 of the display panel 2 to the inputs of the capacitance detection circuitry 36. The capacitance detection circuitry 36 detects the capacitance of the respective common electrodes 16 and the respective Y sensing electrodes 46 and generates capacitance data indicative of the detected capacitance. The controller 37 senses an input object on the basis of the capacitance data received from the capacitance detection circuitry 36. More specifically, the controller 37 calculates the position at which an object is placed into contact with the display panel 2 in the X axis direction, on the basis of the capacitance of the respective common electrodes 16 and calculates the position at which the object is placed into contact with the display panel in the Y axis direction, on the basis of the capacitance of the respective Y sensing electrodes 46.

When mutual capacitance touch sensing is performed, the display driver 3 operates as follows: The controller 37 of the display driver 3 asserts the switch control signal touch_sel. In response to the assertion of the switch control signal touch_sel, the switches 18 of the switch circuitry 15 and the switches 26 of the switch circuitry 19 are turned on and the switches 27 of the VCOM switch circuitry 21 and the switches 28 of the VCOM switch circuitry 22 are turned off. This allows connecting the respective common electrodes 16 to the source input terminals 13 in the display panel 2. Meanwhile, the selector 35 connects the source output terminals 31 to the outputs of the transmitter driver 38 under the control of the controller 37. The transmitter driver 38 supplies drive voltages to the respective common electrodes 16 from the source output terminals 31 via the selector 35, to thereby drive the common electrodes 16. The capacitance detection circuitry 36 detects the capacitance between the respective common electrodes 16 and the respective Y sensing electrode 46 to generate the capacitance data. The controller 37 calculates the position at which an object is placed into contact with the display panel 2, on the basis of the capacitance between the respective common electrodes 16 and the respective Y sensing electrode 46 indicated in the capacitance data received from the capacitance detection circuitry 36.

The configuration of the display device 1 illustrated in FIG. 4 eliminates the need of providing external connection terminals dedicated to connect the common electrodes 16 to the capacitance detection circuitry 36, in the display panel 2. This allows reducing the number of external connection terminals of the display panel 2, which is configured to use the common electrodes 16 also as touch sensing electrodes.

It should be noted that the display device 1 illustrated in FIG. 4 is not necessarily configured to perform mutual capacitance touch sensing. In this case, it is not necessary to provide the transmitter driver 38 in the display driver 3.

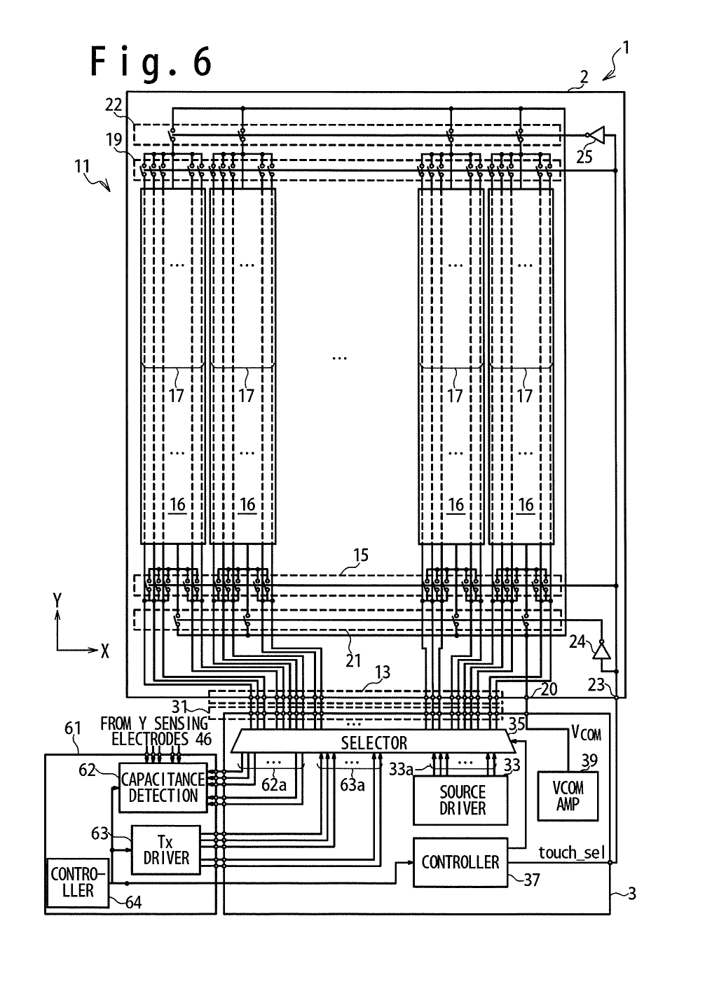

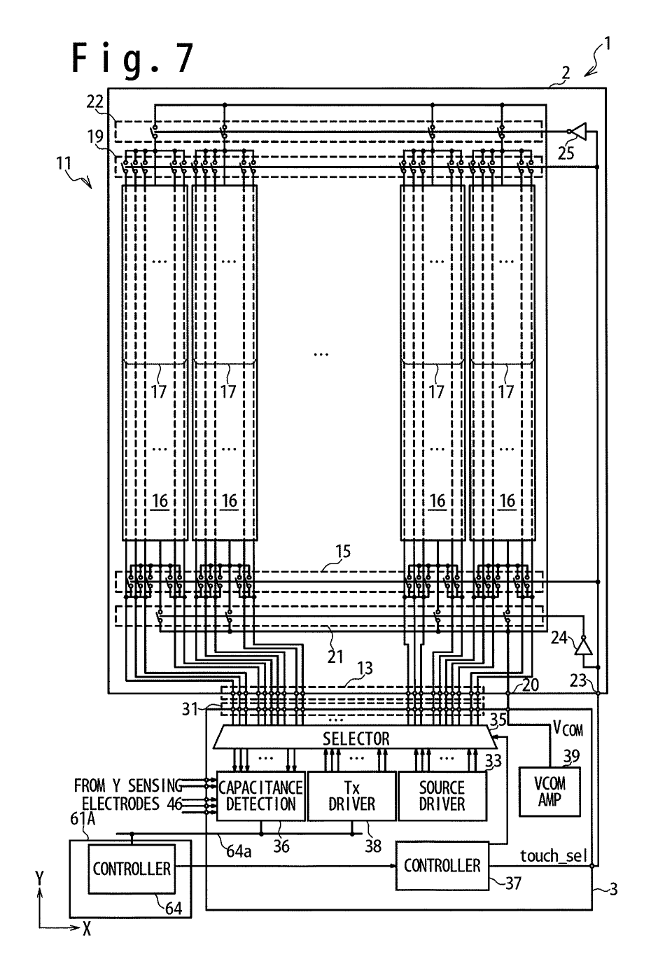

Although FIG. 4 illustrates the configuration in which the display driver 3 includes both of circuitry used to sense an input object (e.g., the capacitance detection circuitry 36 and the transmitter driver 38) and circuitry used to drive the source lines 17 (e.g., the source driver circuitry 33), at least a portion of the circuitry used to sense an input object may be integrated within a semiconductor chip provided separately from the display driver 3. FIGS. 6 and 7 illustrate the display device 1 thus configured.

Illustrated in FIG. 6 is the configuration in which the display device 1 includes an external touch controller 61 provided separately from the display driver 3. In the configuration illustrated in FIG. 6, a capacitance detection circuitry 62, a transmitter driver 63 and a controller 64 are integrated in the external touch controller 61.

The capacitance detection circuitry 62 is configured to detect the capacitance of conductors connected to the inputs thereof and generate capacitance data indicative of the detected capacitance. The capacitance detection circuitry 62 is used to detect the capacitance of the respective common electrodes 16, the capacitance of the respective Y sensing electrodes 46 and the capacitance between the respective common electrodes 16 and the respective Y sensing electrodes 46.

The transmitter driver 63 drives the common electrodes 16, which are used as transmitter electrodes when mutual capacitance touch sensing is performed.

The controller 64 supplies timing control signals controlling the operation timing in the touch sensing to the capacitance detection circuitry 62, the transmitter driver 63 and the controller 37 of the display driver 3. Additionally, the controller 64 calculates the position at which an object is placed into contact with the display panel 2, on the basis of the capacitance detected by the capacitance detection circuitry 62 (including the capacitance of the respective common electrodes 16, the capacitance of the respective Y sensing electrodes 46 and the capacitance between the respective common electrodes 16 and the respective Y sensing electrodes 46). Provided in the display driver 3 are interconnections 62a which connect the capacitance detection circuitry 62 to the selector 35 and interconnections 63a which connect the transmitter driver 63 to the selector 35. The selector 35 is responsive to a control signal received from the controller 37 for connecting the source output terminals 31 to any of the interconnections 62a connected to the capacitance detection circuitry 62, the interconnections 63a connected to the transmitter driver 63 and the interconnections 33a connected to the source driver circuitry 33.

The operation of the display device 1 illustrated in FIG. 6 is almost the same as that of the display device 1 illustrated in FIG. 4, except for that the capacitance detection circuitry 62 and the transmitter driver 63 of the external touch controller 61 are used in place of the capacitance detection circuitry 36 and the transmitter driver 38 and that the position at which an object is placed into contact with the display panel 2 is calculated by the controller 64 of the external touch controller 61.

FIG. 7 illustrates a configuration in which the display device 1 includes an external touch controller 61A provided separately from the display driver 3. In the configuration illustrated in FIG. 7, a controller 64 which calculates the position at which an object is placed into contact with the display panel 2 is integrated in the external touch controller 61A. The capacitance detection circuitry 36 and the transmitter driver 38 are integrated in the display driver 3 and the controller 64 is connected to the capacitance detection circuitry 36 and the transmitter driver 38 via a data/control bus 64a. The controller 64 receives the capacitance data indicative of the capacitance detected by the capacitance detection circuitry 36 (including the capacitance of the respective common electrodes 16, the capacitance of the respective Y sensing electrodes 46 and the capacitance between the respective common electrodes 16 and the respective Y sensing electrodes 46) via the data/control bus 64a, and calculates the position at which an object is placed into contact with the display panel 2 on the basis of the received capacitance data (that is, on the basis of the capacitance detected by the capacitance detection circuitry 36). The controller 64 also transmits control data controlling the capacitance detection circuitry 36 and the transmitter driver 38 via the data/control bus 64a.

The operation of the display device 1 illustrated in FIG. 7 is almost the same as that of the display device 1 illustrated in FIG. 4, except for that the position at which an object is placed into contact with the display panel 2 is calculated by the controller 64 of the external touch controller 61A in place of the controller 37 of the display driver 3.

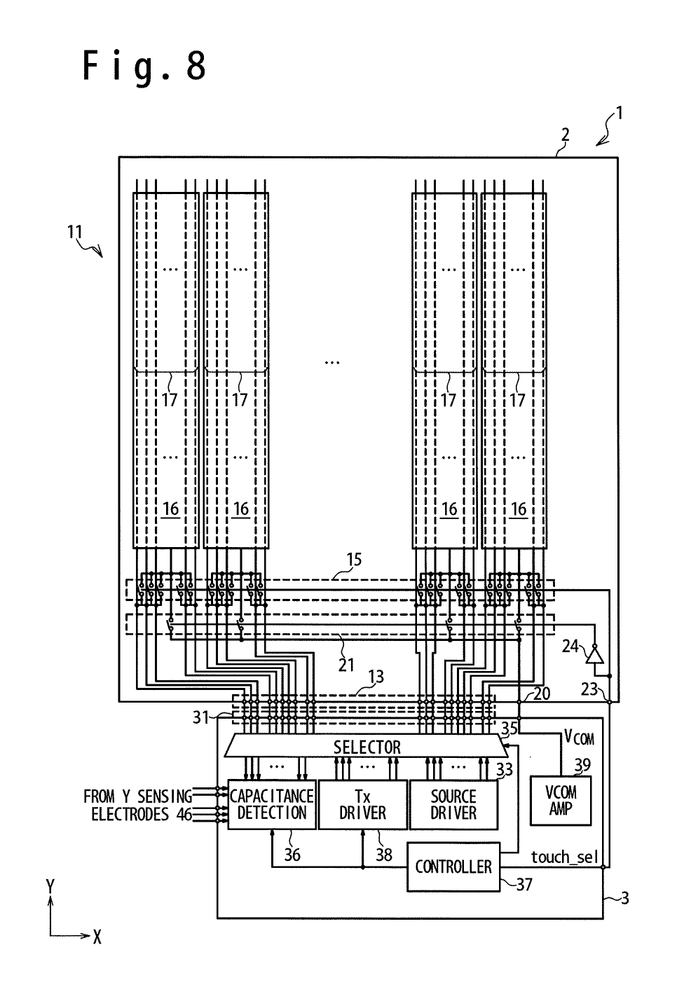

FIG. 8 illustrates a display device 1 in another embodiment. The display device 1 illustrated in FIG. 8 is different from the display device 1 illustrated in FIG. 4 in the configuration of the display panel 2. More specifically, the switch circuitry 19 and the VCOM switch circuitry 22, which are positioned away from the display driver 3 (at a position opposite to the display driver 3 across the common electrodes 16) in the configuration illustrated in FIG. 4, are removed from the display panel 2 in the configuration illustrated in FIG. 8. The display device 1 configured as illustrated in FIG. 8 operates substantially in the same way as the display device 1 illustrated in FIG. 4, although the electrical connections are weaken between the common electrodes 16 and the source lines 17 and between the common electrodes 16 and the VCOM input terminal 20. The configuration illustrated in FIG. 8, which does not require a region to dispose the switch circuitry 19 and the VCOM switch circuitry 22, effectively reduces the area of the display panel 2.

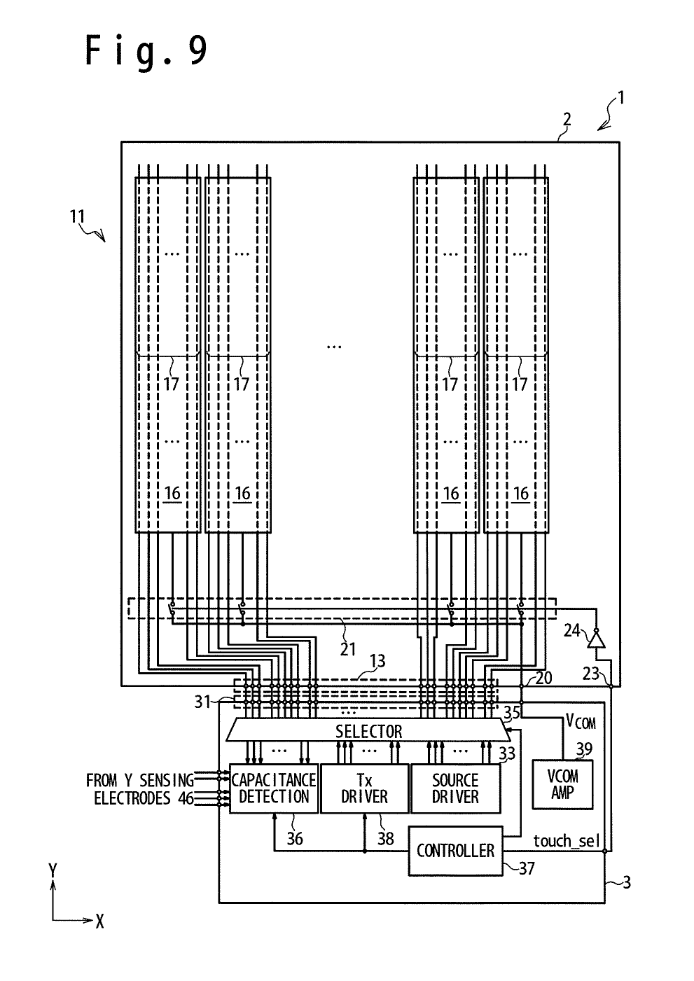

FIG. 9 illustrates a display device 1 in still another embodiment. In the configuration illustrated in FIG. 9, the source lines 17 are used as touch sensing electrodes (in place of the common electrodes 16). Along with this, the switch circuitry 15 and the switch circuitry 19 are removed from the display panel 2.

In the display device 1 illustrated in FIG. 9, when the drive operation is performed, the display driver 3 operates as follows.

The controller 37 of the display driver 3 negates the switch control signal touch_sel. In response to the negation of the switch control signal touch_sel, the switches 27 of the VCOM switch circuitry 21 are turned on to thereby connect the respective common electrodes 16 to the VCOM amplifier 39. The VCOM amplifier 39 supplies the common voltage V_{COM} to the respective common electrodes 16. Meanwhile, the selector 35 connects the source output terminals 31 to the outputs of the source driver circuitry 33 under the control of the controller 37. This allows the respective source lines 17 of the display panel 2 to the outputs of the source driver circuitry 33. The source driver circuitry 33 supplies source signals to the respective source lines 17 from the source output terminals 31 via the selector 35. This allows driving the respective pixel circuits of the display circuitry 11.

When self-capacitance touch sensing is performed, the display driver 3 operates as follows: The controller 37 of the display driver 3 asserts the switch control signal touch_sel. In response to the assertion of the switch control signal touch_sel, the respective switches 27 of the VCOM switch circuitry 21 are turned off. Meanwhile, the selector 35 connects the source output terminals 31 to the inputs of the capacitance detection circuitry 36 under the control of the controller 37. This allows connecting the respective source lines 17 of the display panel 2 to the inputs of the capacitance detection circuitry 36. The capacitance detection circuitry 36 detects the capacitance of the respective source lines 17 and the respective Y sensing electrodes 46 and generates capacitance data indicative of the detected capacitance. The controller 37 senses an input object on the basis of the capacitance data received from the capacitance detection circuitry 36 (that is, on the basis of the capacitance of the respective source lines 17 and the respective Y sensing electrodes 46). More specifically, the controller 37 calculates the position at which an object is placed into contact with the display panel 2 in the X axis direction, on the basis of the capacitance of the respective source lines 17 and calculates the position at which the object is placed into contact with the display panel 2 in the Y axis direction, on the basis of the capacitance of the respective X sensing electrodes 46.

When mutual capacitance touch sensing is performed, the display driver 3 operates as follows: The controller 37 of the display driver 3 asserts the switch control signal touch_sel. In response to the assertion of the switch control signal touch_sel, the switches 27 of the VCOM switch circuitry 21 are turned off. Meanwhile, the selector 35 connects the source output terminals 31 to the outputs of the transmitter driver 38 under the control of the controller 37. The transmitter driver 38 supplies drive voltages to the source lines 17 of the display panel 2 from the source output terminals 31 via the selector 35. The capacitance detection circuitry 36 detects the capacitance between the respective common electrodes 16 and the respective Y sensing electrodes 46 and generates capacitance data indicative of the detected capacitance.

The controller 37 calculates the position at which an object is placed into contact with the display panel 2 on the basis of the capacitance data received from the capacitance detection circuitry 36 (that is, the capacitance between the respective source lines 17 and the respective Y sensing electrodes 46).

The configuration illustrated in FIG. 9, in which the source lines 17 are also used as touch sensing electrodes, eliminates the need of providing external connection terminals connected to touch sensing electrodes separately from the source input terminals 13 connected to the source lines 17. Accordingly, the configuration illustrated in FIG. 9 allows reducing the number of external connection terminals of the display panel 2.

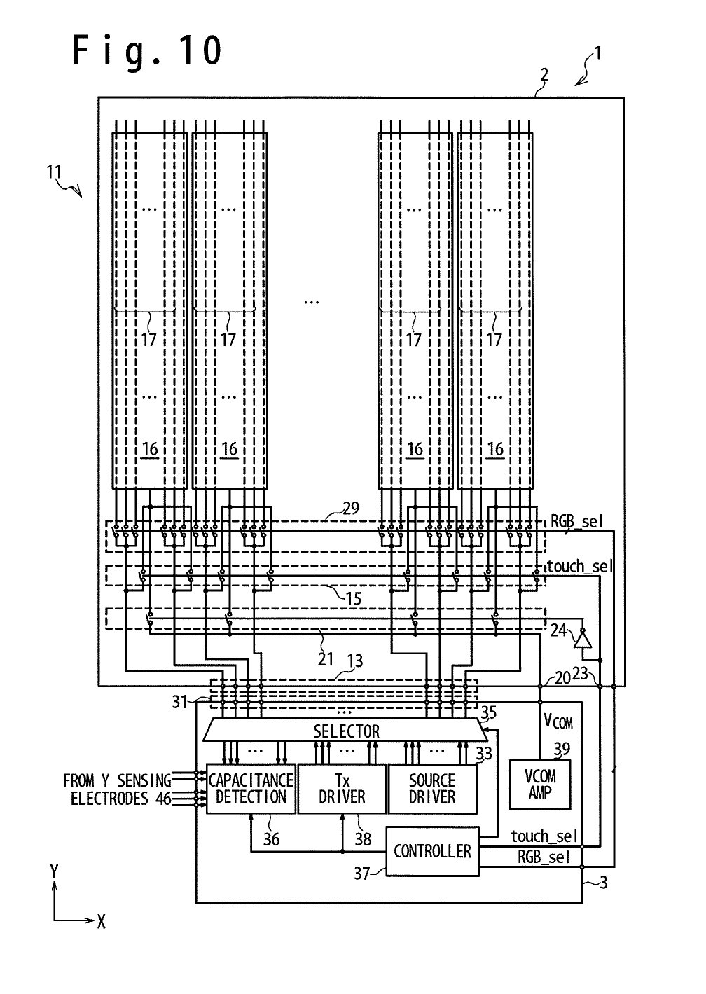

FIG. 10 illustrates a display device 1 in still another embodiment. The configuration of the display device 1 illustrated in FIG. 10 is similar to that of the display device 1 illustrated in FIG. 8; the difference is that the source lines 17 are driven through time divisional driving in the display device 1 illustrated in FIG. 10. More specifically, three source lines 17 are associated with each source input terminal 13 of the display panel 2 and the three source lines 17 are respectively connected to pixel circuits of differently-colored subpixels.

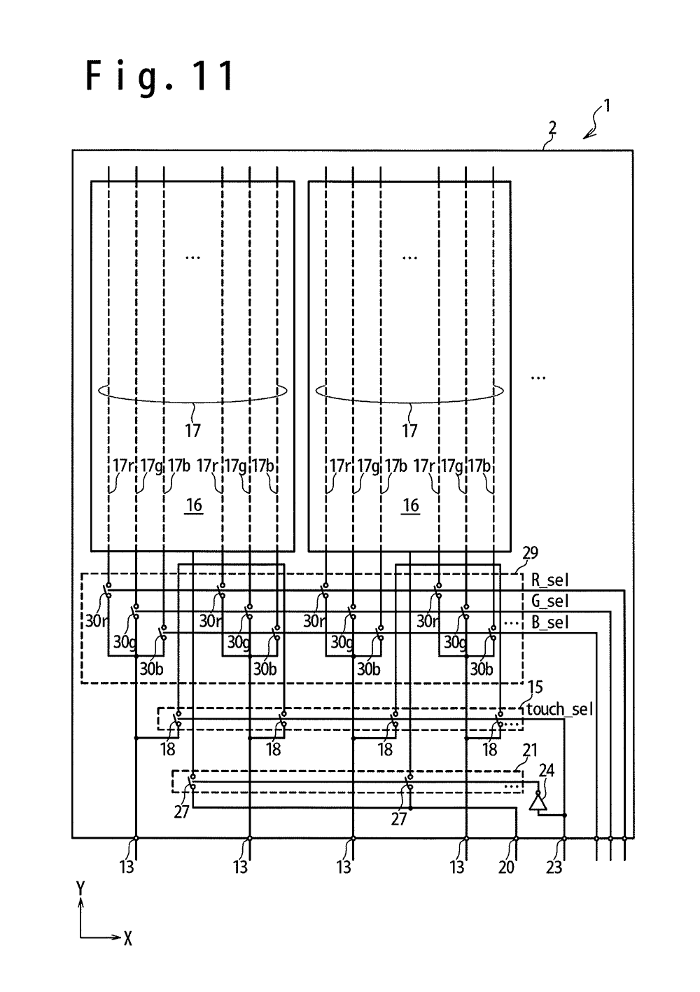

As illustrated in FIG. 11, the three source lines 17 associated with each source input terminal 13 includes a source line 17r associated with red-colored subpixels, a source line 17g associated with green-colored subpixels, and a source line 17b associated with blue-colored subpixels. Pixel circuits of red-colored subpixels (not illustrated) are arranged along the source lines 17r, and the pixel circuits of the red-colored subpixels are connected to the source lines 17r. Similarly, pixel circuits of green-colored subpixels (not illustrated) are arranged along the source lines 17g, and the pixel circuits of the green-colored subpixels are connected to the source lines 17g. Also, pixel circuits of blue-colored subpixels (not illustrated) are arranged along the source lines 17b, and the pixel circuits of the blue-colored subpixels are connected to the source lines 17b.

In the configuration illustrated in FIG. 10, a source line select circuitry 29 is provided in the display panel 2 to achieve time divisional driving. As illustrated in FIG. 11, the source line select circuitry 29 includes switches 30r connected between the source input terminals 13 and the source lines 17r associated with the red-colored subpixels, switches 30g connected between the source input terminals 13 and the source lines 17g associated with the green-colored subpixels, and switches 30b connected between the source input terminals 13 and the source lines 17b associated with the blue-colored subpixels. The switches 30r, 30g and 30b respectively receive a red select signal R_sel, a green select signal G_sel and a blue select signal B_sel, which are generated by the controller 37 of the display driver 3. The switches 30r are responsive to the red select signal R_sel, the switches 30g are responsive to the green select signal G_sel, and the switches 30b are responsive to the blue select signal B_sel. In driving the respective pixel circuits of the display circuitry 11, the switches 30r, 30g and 30b are time-divisionally turned on under the controls of the red select signal R_sel, the green select signal G_sel and the blue select signal B_sel.

Next, a description is given of the operation of the display device 1 illustrated in FIGS. 10 and 11.

When the drive operation is performed, the display driver 3 operates as follows. The controller 37 of the display driver 3 negates the switch control signal touch_sel. In response to the negation of the switch control signal touch_sel, the switches 27 of the VCOM switch circuitry 21 are turned on and the switches 18 of the switch circuitry 15 are turned off. This allows connecting the respective common electrodes 16 to the VCOM amplifier 39. The VCOM amplifier 39 supplies the common voltage V_{COM} to the respective common electrodes 16. Meanwhile, the selector 35 connects the source output terminals 31 to the outputs of the source driver circuitry 33 under the control of the controller 37.

When the pixel circuits of the red-colored subpixels are driven, the controller 37 asserts the red select signal R_sel and negates the green select signal G_sel and the blue select signal B_sel. This results in that the switches 30r are turned on and the source lines 17r associated with the red-colored subpixels are connected to the source input terminals 13. The source driver circuitry 33 supplies source signals to the source input terminals 13 of the display panel 2 via the selector 35. As a result of this operation, the source signals are supplied to the pixel circuits connected to the source lines 17r (that is, the pixel circuits of the red-colored subpixels).

Similarly, when the pixel circuits of the green-colored subpixels are driven, the controller 37 asserts the green select signal G_sel and negates the blue select signal B_sel and the red select signal R_sel. This results in that the switches 30g are turned on and the source lines 17g associated with the red-colored subpixels are connected to the source input terminals 13. The source driver circuitry 33 supplies source signals to the source input terminals 13 of the display panel 2 via the selector 35. As a result of this operation, the source signals are supplied to the pixel circuits connected to the source lines 17g (that is, the pixel circuits of the green-colored subpixels).

Furthermore, when the pixel circuits of the blue-colored subpixels are driven, the controller 37 asserts the green select signal B_sel and negates the red select signal R_sel and the green select signal G_sel. This results in that the switches 30b are turned on and the source lines 17b associated with the red-colored subpixels are connected to the source input terminals 13. The source driver circuitry 33 supplies source signals to the source input terminals 13 of the display panel 2 via the selector 35. As a result of this operation, the source signals are supplied to the pixel circuits connected to the source lines 17b (that is, the pixel circuits of the blue-colored subpixels). The respective pixel circuits of the display circuitry 11 are driven through the above-described operation.

When self-capacitance touch sensing is, the display driver 3 operates as follows: The controller 37 of the display driver 3 asserts the switch control signal touch_sel. In response to the assertion of the switch control signal touch_sel, the switches 18 of the switch circuitry 15 are turned on and the switches 27 of the VCOM switch circuitry 21 are turned off. This allows connecting the respective common electrodes 16 to the source input terminals 13 in the display panel 2. Meanwhile, the selector 35 connects the source output terminals 31 to the inputs of the capacitance detection circuitry 36 under the control of the controller 37. This allows connecting the respective common electrodes 16 of the display panel 2 to the inputs of the capacitance detection circuitry 36. The capacitance detection circuitry 36 detects the capacitance of the respective common electrodes 16 and the respective Y sensing electrodes 46 and generates capacitance data indicative of the detected capacitance. The controller 37 senses an input object on the basis of the capacitance data received from the capacitance detection circuitry 36. More specifically, the controller 37 calculates the position at which an object is placed into contact with the display panel 2 in the X axis direction, on the basis of the capacitance of the respective common electrodes 16 and calculates the position at which the object is placed into contact with the display panel in the Y axis direction, on the basis of the capacitance of the respective Y sensing electrodes 46.

When mutual capacitance touch sensing is performed, the display driver 3 operates as follows: The controller 37 of the display driver 3 asserts the switch control signal touch_sel. In response to the assertion of the switch control signal touch_sel, the switches 18 of the switch circuitry 15 are turned on and the switches 27 of the VCOM switch circuitry 21 are turned off. This allows connecting the respective common electrodes 16 to the source input terminals 13 in the display panel 2. Meanwhile, the selector 35 connects the source output terminals 31 to the outputs of the transmitter driver 38 under the control of the controller 37. The transmitter driver 38 supplies drive voltages to the respective common electrodes 16 from the source output terminals 31 via the selector 35, to thereby drive the common electrodes 16. The capacitance detection circuitry 36 detects the capacitance between the respective common electrodes 16 and the respective Y sensing electrode 46 to generate the capacitance data. The controller 37 calculates the position at which an object is placed into contact with the display panel 2, on the basis of the capacitance data received from the capacitance detection circuitry 36 (that is, on the basis of the capacitance between the respective common electrodes 16 and the respective Y sensing electrode 46).

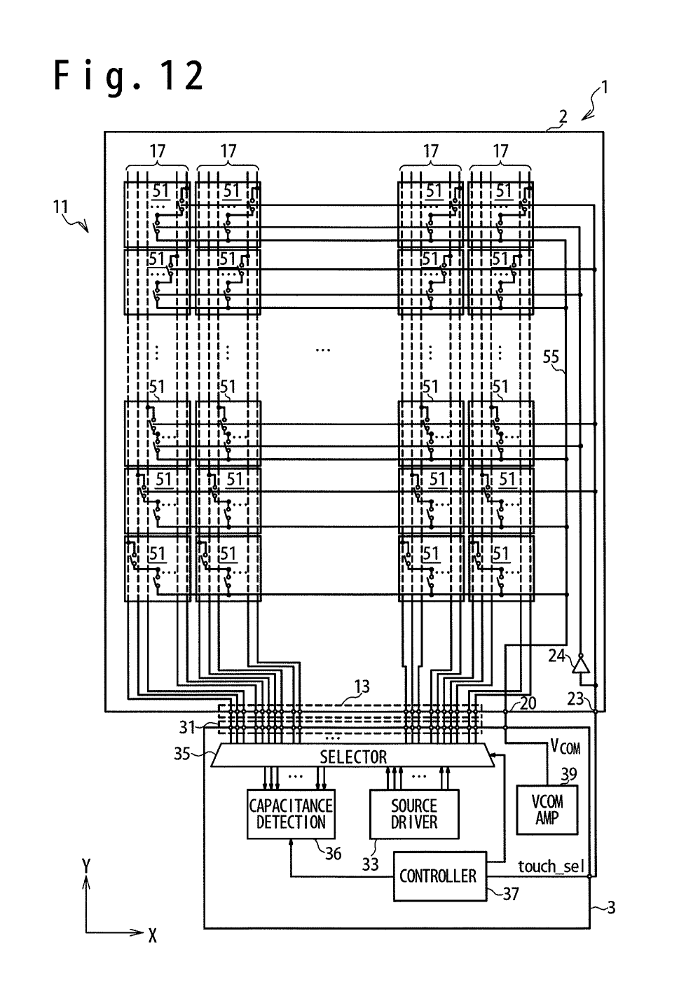

FIG. 12 illustrates a display device 1 in still another embodiment. In the configuration illustrated in FIG. 12, common electrodes 51 are arrayed in a matrix, that is, in a plurality of rows and a plurality of columns, although the common electrodes 16 extended in the Y axis direction are arrayed in the X axis direction in the configuration illustrated in FIG. 4. The common electrodes 51 are arrayed in the X axis direction in each row and arrayed in the Y axis direction in each column. Source lines 17 extended in the Y axis directions are arrayed in the X axis direction, and the source lines 17 are connected to the source input terminals 13, respectively. A plurality of source lines 17 intersect with the common electrodes 51 in each column.

In the present embodiment, the common electrodes 51 arrayed in rows and columns are used as touch sensing electrodes. It should be noted that the configuration illustrated in FIG. 12, in which the common electrodes 51 used as the touch sensing electrodes are arrayed in rows and columns, is suitable for self-capacitance touch sensing. The configuration in which an input object is sensed through self-capacitance touch sensing with respect to the display panel 2 in which the common electrodes 16 and the Y sensing electrodes 46 intersect with one another as in the above-described embodiments may suffer from a problem of so-called “ghost” when an object(s) is placed into the display panel 2 at a plurality of positions. The present embodiment, in which the common electrodes 51 used as the touch sensing electrodes are arrayed in rows and columns, is free from the problem of “ghost”.

Accordingly, mutual capacitance touch sensing is not performed in the display device 1 illustrated in FIG. 12. In the present embodiment, the display driver 3 is not adapted to mutual capacitance touch sensing and therefore the display driver 3 does not include the transmitter driver 38. It should be noted however that the display device 1 may be configured to be adapted to mutual capacitance touch sensing also in the configuration in which the common electrodes 51 are arrayed in rows and columns.

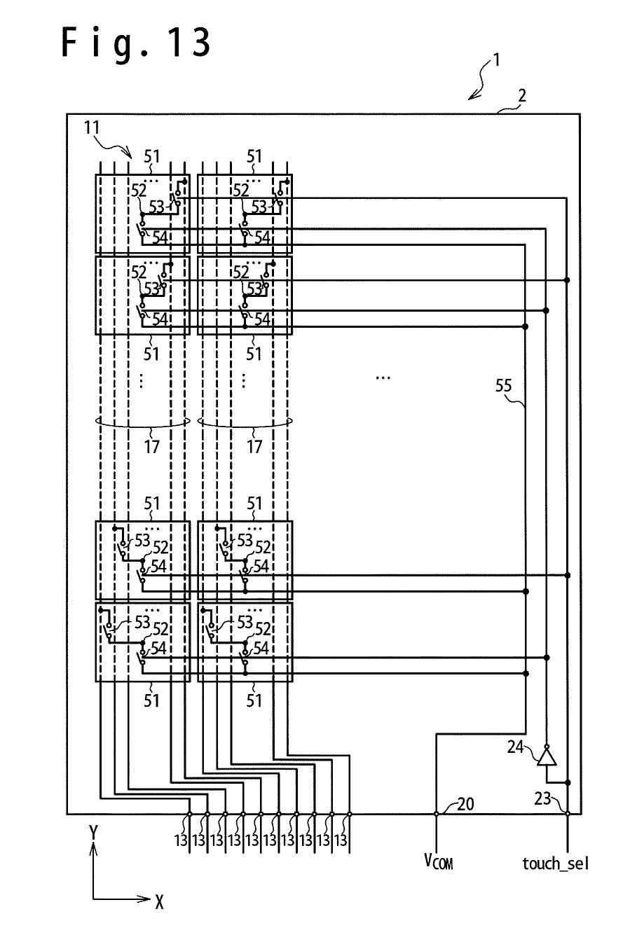

FIG. 13 illustrates details of the display panel 2 of the display device 1 illustrated in FIG. 12. A contact 52 and a pair of switches 53 and 54 are provided for each common electrode 51 in the display panel 2. The contact 52 is connected to the associated common electrode 51. Additionally, the display panel 2 includes an inverter 24 and a VCOM line 55. The inverter 24 has an input connected to the switch control terminal 23 and generates an inverted signal of the switch control signal touch_sel. The VCOM line 55 is connected to the VCOM input terminal 20. The VCOM line 55 is extended in the Y axis direction in the configuration illustrated in FIGS. 12 and 13.

Each switch 53 is connected between the associated contact 52 and one of the source lines 17 associated with each common electrode 51 (the source lines 17 intersecting with each common electrode 51). The switch 53 connected to each common electrode 51 has the function of electrically connecting each common electrode 51 to the associated source input terminal 13 (via the associated source line 17). The switches 53 are operated in response to the switch control signal touch_sel.

The switches 54 are connected between the VCOM line 55 and the contacts 52. In the configuration illustrated in FIG. 13, all the common electrodes 51 are commonly connected to the VCOM line 55 via the associated switches 54. As described later, the common voltage V_{COM} supplied to the VCOM input terminal 20 from the display driver 3 is supplied to the respective common electrodes 51 via the VCOM line 55 and the switches 54. The switches 54 are operated in response to the inverted signal of the switch control signal touch_sel, which is generated by the inverter 24.

Although FIG. 13 illustrates the configuration in which one switch 53 is disposed for each common electrode 51 and each common electrode 51 is connected to one source line 17 via the switch 53, a plurality of switches 53 may be disposed for each common electrode 51 and each common electrode 51 may be connected to a plurality of source lines 17 via the plurality of switches 53. It should be noted however that, with respect to each source line 17, a single common electrode 51 is connected to each source line 17 via the associated switch 53.

Next, a description is given of the operation of the display device 1 configured as illustrated in FIGS. 12 and 13.

When the drive operation is performed, the display driver 3 of the display device 1 operates as follows: The controller 37 of the display driver 3 negates the switch control signal touch_sel. In response to the negation of the switch control signal touch_sel, the switches 54 associated with the respective common electrodes 51 are turned on and the switches 53 associated with the respective common electrodes 51 are turned off. This allows connecting the respective common electrodes 51 to the VCOM amplifier 39. The VCOM amplifier 39 supplies the common voltage V_{COM} to the respective common electrodes 51. Furthermore, the selector 35 connects the source output terminals 31 to the outputs of the source driver circuitry 33 under the control of the controller 37. The source driver circuitry 33 supplies the source signals to the respective source lines 17 of the display panel 2 from the source output terminals 31 via the selector 35. This operation allows driving the respective pixel circuits of the display circuitry 11.

When self-capacitance touch sensing is performed, the display driver 3 operates as follows: The controller 37 of the display driver 3 asserts the switch control signal touch_sel. In response to the assertion of the switch control signal touch_sel, the switches 53 associated with the respective common electrodes 51 are turned on and the switches 54 associated with the respective common electrodes 51 are turned off. This allows connecting the respective common electrodes 51 to the associated source input terminals 13 via the associated source lines 17 in the display panel 2. Meanwhile, the selector 35 connects the source output terminals 31 to the inputs of the capacitance detection circuitry 36 under the control of the controller 37. This allows connecting the respective common electrodes 51 of the display panel 2 to the inputs of the capacitance detection circuitry 36. The capacitance detection circuitry 36 detects the capacitance of the respective common electrodes 51 and generates capacitance data indicative of the detected capacitance. The controller 37 senses an input object on the basis of the capacitance data received from the capacitance detection circuitry 36 (that is, on the basis of the capacitance of the respective common electrodes 51). More specifically, the controller 37 calculates the position at which an object is placed into contact with the display panel 2, on the basis of the capacitance of the respective common electrodes 51.

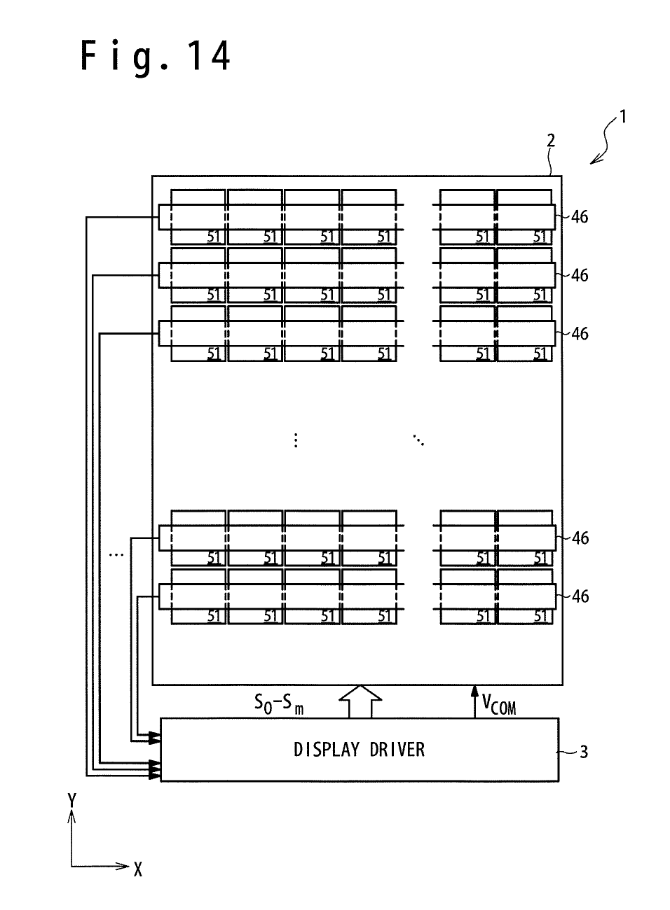

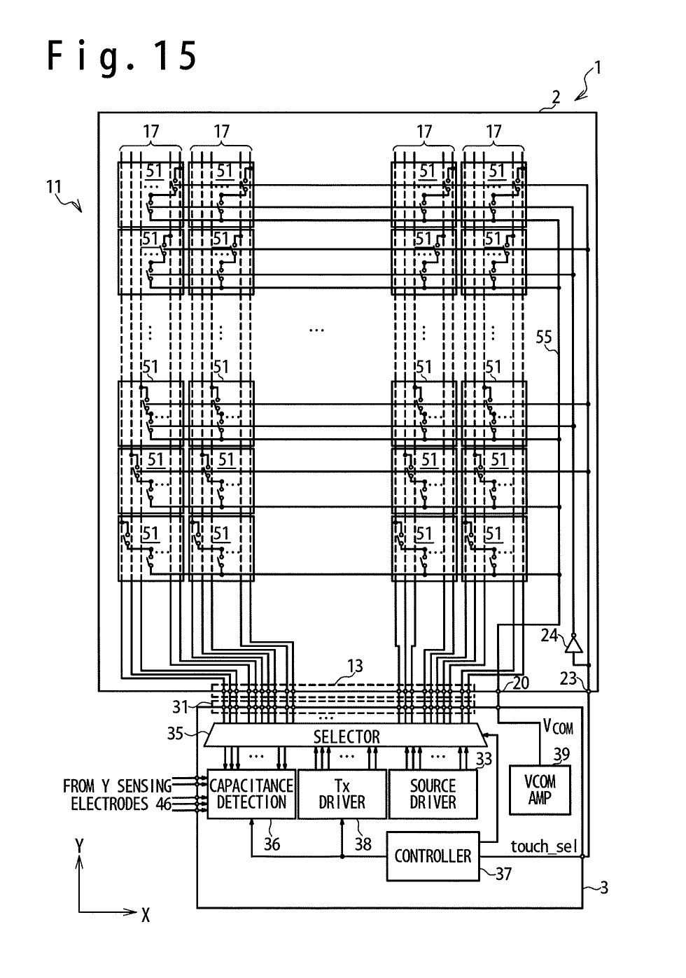

As described above, the display device 1 may be configured to be adapted to mutual capacitance touch sensing, also in the configuration in which the common electrodes 51 are arrayed in rows and columns. FIGS. 14 and 15 illustrate the configuration of the display device 1 thus configured. As illustrated in FIG. 14, the Y sensing electrodes 46 of the display panel 2 are disposed to be respectively associated with the rows of the common electrodes 51 and to intersect with the common electrodes 51 in the associated rows. Additionally, the transmitter driver 38 is incorporated in the display driver 3.

When mutual capacitance touch sensing is performed, the display driver 3 operates as follows: The controller 37 of the display driver 3 asserts the switch control signal touch_sel. In response to the assertion of the switch control signal touch_sel, the switches 53 associated with the respective common electrodes 51 are turned on and the switches 54 associated with the respective common electrodes 51 are turned off. This allows connecting the respective common electrodes 51 to the source input terminals 13 in the display panel 2. Meanwhile, the selector 35 connects the source output terminals 31 to the outputs of the transmitter driver 38 under the control of the controller 37. The transmitter driver 38 supplies drive voltages to the respective common electrodes 51 from the source output terminals 31 via the selector 35. The capacitance detection circuitry 36 detects the capacitance between the respective common electrodes 51 and the respective Y sensing electrode 46 to generate the capacitance data. The controller 37 calculates the position at which an object is placed into contact with the display panel 2, on the basis of the capacitance data received from the capacitance detection circuitry 36 (that is, on the basis of the capacitance between the respective common electrodes 51 and the respective Y sensing electrode 46).

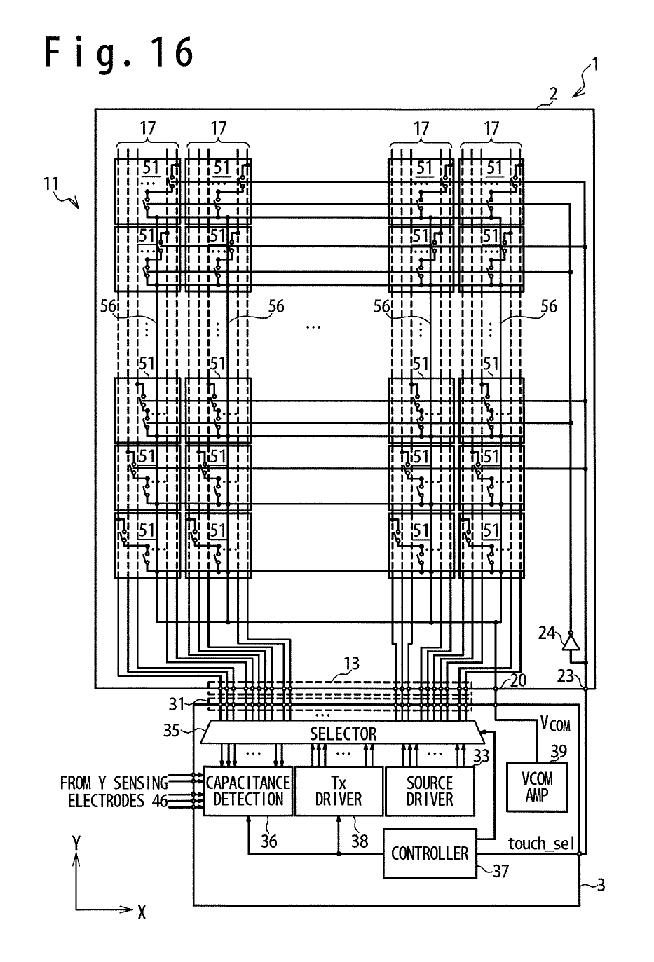

Although all the common electrodes 51 are connected to the VCOM line 55 via the switches 54 in the configurations illustrated in FIGS. 12 to 15, VCOM common lines 56 may be alternatively disposed along the respective columns of the common electrodes 51 as illustrated in FIG. 16. The VCOM lines 56 are connected to the VCOM input terminal 20 and used to supply the common voltage V_{COM} to the respective common electrodes 51.

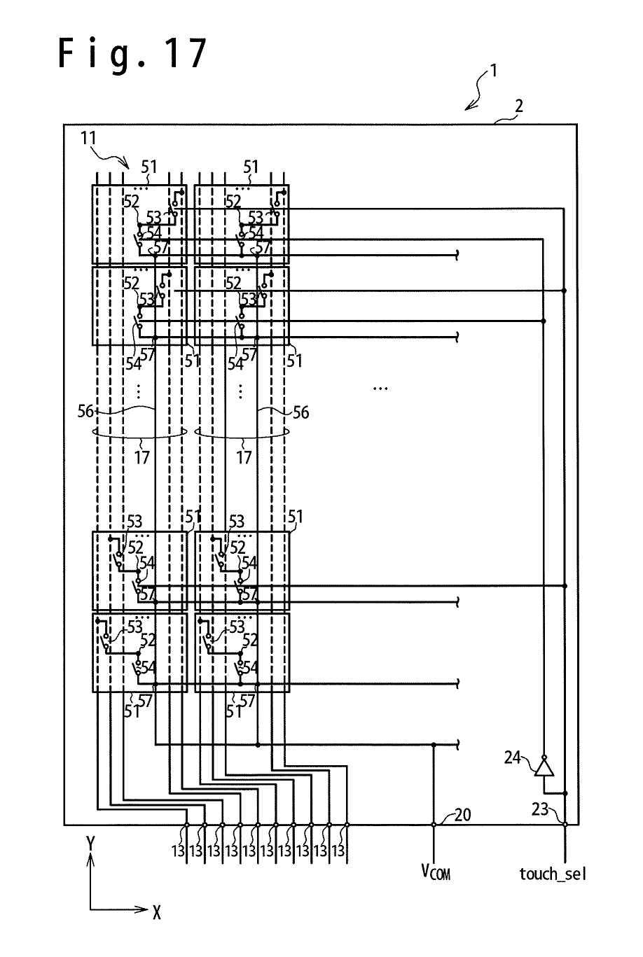

FIG. 17 illustrates the configuration of the display panel 2 in this case. Connection nodes 57 are provided for the respective common electrodes 51 and each VCOM line 56 is connected to the connection nodes 57 of the common electrodes 51 in the associated column. It would be easily understood by persons skilled in the art that the operation of the display device 1 configured as illustrated in FIGS. 16 and 17 is substantially the same as that of the display device 1 configured as illustrated in FIGS. 14 and 15, although only the routes via which the common voltage V_{COM} is supplied to the respective common electrodes 51 are different.

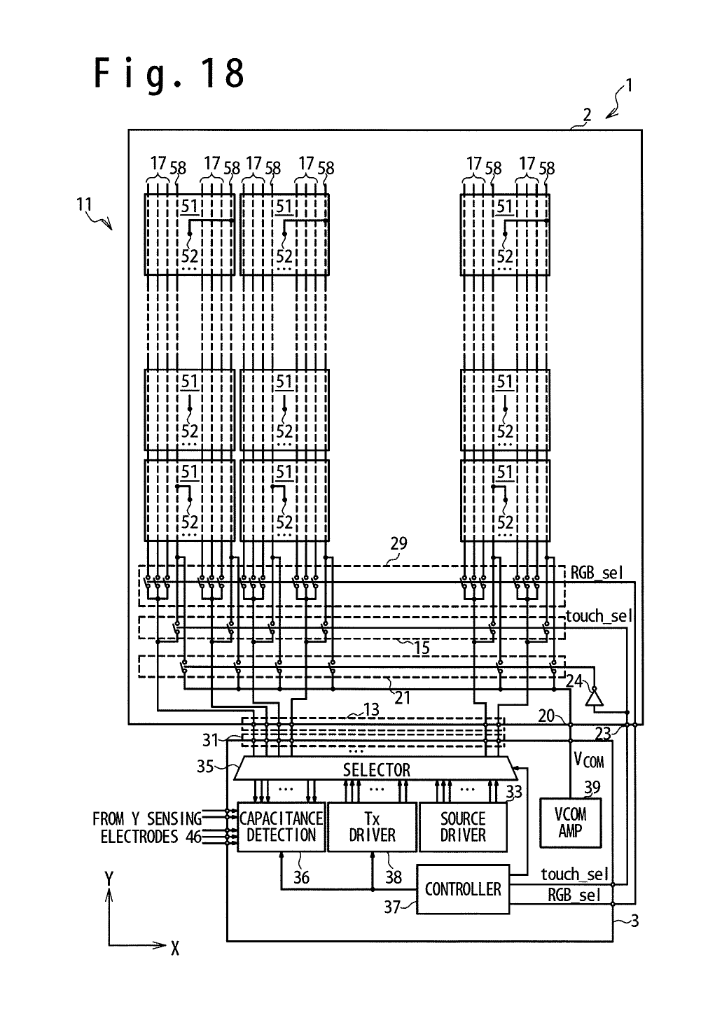

FIG. 18 illustrates a display device 1 in still another embodiment. In the display device 1 configured as illustrated in FIG. 18, the common electrodes 51 are arrayed in rows and columns similarly to the display device 1 configured as illustrated in FIGS. 14 and 15; the difference is that the source lines 17 are driven through time divisional driving in the display device 1 illustrated in FIG. 18. More specifically, three source lines 17 are disposed for one source input terminal 13 in the display panel 2 and the three source lines 17 are connected to pixel circuits of differently-colored subpixels.

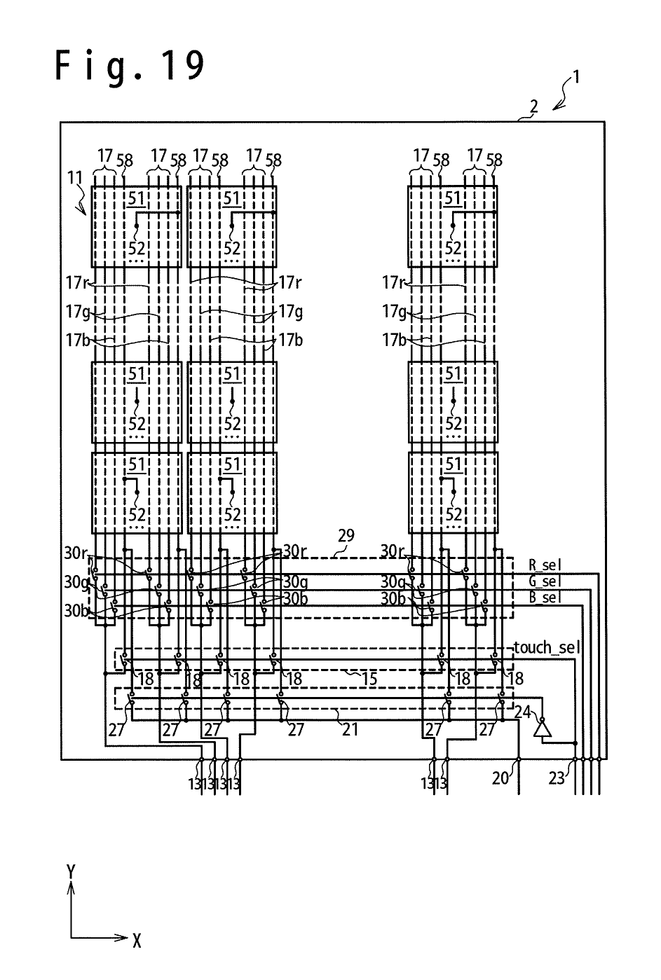

As illustrated in FIG. 19, the three source lines 17 associated with each source input terminal 13 includes a source line 17r associated with red-colored subpixels, a source line 17g associated with green-colored subpixels, and a source line 17b associated with blue-colored subpixels. Pixel circuits of red-colored subpixels (not illustrated) are arranged along the source lines 17r, and the pixel circuits of the red-colored subpixels are connected to the source lines 17r. Similarly, pixel circuits of green-colored subpixels (not illustrated) are arranged along the source lines 17g, and the pixel circuits of the green-colored subpixels are connected to the source lines 17g. Also, pixel circuits of blue-colored subpixels (not illustrated) are arranged along the source lines 17b, and the pixel circuits of the blue-colored subpixels are connected to the source lines 17b.

A source line select circuitry 29 is provided in the display panel 2 to achieve time-divisional driving. The source line select circuitry 29 includes switches 30r connected between the source input terminals 13 and the source lines 17r associated with the red-colored subpixels, switches 30g connected between the source input terminals 13 and the source lines 17g associated with the green-colored subpixels, and switches 30b connected between the source input terminals 13 and the source lines 17b associated with the blue-colored subpixels. The switches 30r, 30g and 30b respectively receive a red select signal R_sel, a green select signal G_sel and a blue select signal B_sel, which are generated by the controller 37 of the display driver 3. The switches 30r are responsive to the red select signal R_sel, the switches 30g are responsive to the green select signal G_sel, and the switches 30b are responsive to the blue select signal B_sel.

Additionally, a connection line 58 associated with each source input terminal 13 is provided. The connection line 58 is provided along three source lines 17r, 17g and 17b associated with each source input terminal 13. A plurality of connection lines 58 are disposed for each column of the common electrodes 51 and the common electrodes 51 are connected to different connection lines 58. It should be noted that, although each common electrode 51 may be connected to a plurality of connection lines 58, the number of the common electrode 51 connected to each connection line 58 is one. Each connection line 58 is connected to the associated source input terminal 13 via the associated switch 18 of the switch circuitry 15.

Next, a description is given of the operation of the display device 1 configured as illustrated in FIGS. 18 and 19. When the drive operation is performed, the display driver 3 operates as follows. The controller 37 of the display driver 3 negates the switch control signal touch_sel. In response to the negation of the switch control signal touch_sel, the switches 27 of the VCOM switch circuitry 21 are turned on and the switches 18 of the switch circuitry 15 are turned off. This allows connecting the respective common electrodes 51 to the VCOM amplifier 39. The VCOM amplifier 39 supplies the common voltage V_{COM} to the respective common electrodes 51. Meanwhile, the selector 35 connects the source output terminals 31 to the outputs of the source driver circuitry 33 under the control of the controller 37.

When the pixel circuits of the red-colored subpixels are driven, the controller 37 asserts the red select signal R_sel and negates the green select signal G_sel and the blue select signal B_sel. This results in that the source lines 17r associated with the red-colored subpixels are connected to the source input terminals 13. The source driver circuitry 33 supplies source signals to the source input terminals 13 of the display panel 2 via the selector 35. As a result of this operation, the source signals are supplied to the pixel circuits connected to the source lines 17r (that is, the pixel circuits of the red-colored subpixels).

Similarly, when the pixel circuits of the green-colored subpixels are driven, the controller 37 asserts the green select signal G_sel and negates the blue select signal B_sel and the red select signal R_sel. This results in that the source lines 17g associated with the red-colored subpixels are connected to the source input terminals 13. The source driver circuitry 33 supplies source signals to the source input terminals 13 of the display panel 2 via the selector 35. As a result of this operation, the source signals are supplied to the pixel circuits connected to the source lines 17g (that is, the pixel circuits of the green-colored subpixels).

Furthermore, when the pixel circuits of the blue-colored subpixels are driven, the controller 37 asserts the green select signal B_sel and negates the red select signal R_sel and the green select signal G_sel. This results in that the source lines 17b associated with the red-colored subpixels are connected to the source input terminals 13. The source driver circuitry 33 supplies source signals to the source input terminals 13 of the display panel 2 via the selector 35. As a result of this operation, the source signals are supplied to the pixel circuits connected to the source lines 17b (that is, the pixel circuits of the blue-colored subpixels). The respective pixel circuits of the display circuitry 11 are driven through the above-described operation.

When self-capacitance touch sensing is performed, the display driver 3 operates as follows: The controller 37 of the display driver 3 asserts the switch control signal touch_sel. In response to the assertion of the switch control signal touch_sel, the switches 18 of the switch circuitry 15 are turned on and the switches 27 of the VCOM switch circuitry 21 are turned off. This allows connecting the respective common electrodes 51 to the source input terminals 13 in the display panel 2. Meanwhile, the selector 35 connects the source output terminals 31 to the inputs of the capacitance detection circuitry 36 under the control of the controller 37. This allows connecting the respective common electrodes 51 of the display panel 2 to the inputs of the capacitance detection circuitry 36. The capacitance detection circuitry 36 detects the capacitance of the respective common electrodes 51 and generates capacitance data indicative of the detected capacitance. The controller 37 senses an input object on the basis of the capacitance data received from the capacitance detection circuitry 36. More specifically, the controller 37 calculates the position at which an object is placed into contact with the display panel 2, on the basis of the capacitance of the respective common electrodes 51.

When mutual capacitance touch sensing is performed, the display driver 3 operates as follows: The controller 37 of the display driver 3 asserts the switch control signal touch_sel. In response to the assertion of the switch control signal touch_sel, the switches 18 of the switch circuitry 15 are turned on and the switches 27 of the VCOM switch circuitry 21 are turned off. This allows connecting the respective common electrodes 51 to the source input terminals 13 in the display panel 2. Meanwhile, the selector 35 connects the source output terminals 31 to the outputs of the transmitter driver 38 under the control of the controller 37. The transmitter driver 38 supplies drive voltages to the respective common electrodes 16 from the source output terminals 31 via the selector 35, to thereby drive the common electrodes 51. The capacitance detection circuitry 36 detects the capacitance between the respective common electrodes 51 and the respective Y sensing electrode 46 to generate the capacitance data. The controller 37 calculates the position at which an object is placed into contact with the display panel 2, on the basis of the capacitance data received from the capacitance detection circuitry 36 (that is, on the basis of the capacitance between the respective common electrodes 51 and the respective Y sensing electrode 46).

The configuration illustrated in FIGS. 18 and 19 advantageously eliminates the need of individually providing a switch for each common electrode 51, although the connection lines 58 are disposed in addition to the source lines 17. In the configurations illustrated in FIGS. 12 to 17, it is necessary to dispose the switches 53 and 54 in the array of the common electrodes 51 so as to bypass the respective pixel circuits of the display circuitry 11. This may complicate the layout design of the display panel 2. In contrast, the configuration illustrated in FIGS. 18 and 19, in which the switches 18 which electrically connect the respective common electrodes 51 to the source input terminals 13 are concentrated in the switch circuitry 15 disposed near the source input terminal 13, effectively facilitates the layout design.

Although various embodiments of the present disclosure have been specifically described, the present invention must not be construed as being limited to the above-described embodiments. It would be understood by persons skilled in the art that the present invention may be implemented with various modifications.

What is claimed is:

1. A display driver, comprising:
a plurality of source output terminals configured to connect to a plurality of source input terminals of a display panel;
a source driver circuitry configured to provide source signals to the source input terminals;
a plurality of interconnections connected to a capacitance detection circuitry configured to perform capacitive sensing in a sensing region of the display panel, and
a selector configured to selectively connect the source output terminals to the source driver circuitry and the interconnections.

2. The display driver according to claim 1, wherein the selector is configured to connect the source output terminals to the source driver circuitry in a display drive operation and connect the source output terminals to the interconnections when performing capacitive sensing.

3. The display driver according to claim 1, further comprising the capacitance detection circuitry.

4. The display driver according to claim 1, further comprising a controller configured to perform capacitive sensing based on a capacitance detected by the capacitance detection circuitry.

5. The display driver according to claim 1, further comprising a transmitter circuitry,
wherein, in a mutual capacitance capacitive sensing operation, the transmitter circuitry generates drive voltages to a plurality of first sensing electrodes of the display panel, the selector connects the source output terminals to the transmitter circuitry, and the capacitance detection circuitry detects capacitance between the first sensing electrodes and a plurality of second sensing electrodes of the display panel to generate capacitance data.

6. The display driver according to claim 5, wherein the transmitter circuitry transmits the drive voltages to one or more of common electrodes of the display panel.

7. A display device, comprising:
a display panel including a plurality of source lines and a plurality of source input terminals;
a source driver circuitry configured to supply source signals to be supplied to the plurality of source lines, to the plurality of source input terminals;
a capacitance detection circuitry configured to perform capacitive sensing in a sensing region of the display panel;
a controller configured to detect an input object based on a capacitance detected by the capacitance detection circuitry; and
a selector configured to selectively connect the source input terminals to the source driver circuitry and the capacitance detection circuitry.

8. The display device according to claim 7, wherein the display panel further includes:
a plurality of common electrodes; and
first switches each of which is connected between each of the common electrodes and at least one associated source input terminal out of the plurality of source input terminals, the at least one associated source input terminal being associated with each of the common electrodes,
wherein, the selector is configured to connect the plurality of source input terminals to the source driver circuitry in a display drive operation,
wherein the first switches are configured to electrically disconnect the common electrodes from the plurality of source input terminals in the display operation, and
wherein the selector is configured to connect the plurality of source input terminals to the capacitance detection circuitry in a capacitive sensing operation, and
wherein each of the first switches is configured to electrically connect each of the common electrodes and the at least one associated source input terminals in the capacitive sensing operation.

9. The display device according to claim 8, wherein the plurality of source lines is connected in a one-to-one relationship to the plurality of source input terminals,
wherein the first switches are connected to first ends of source lines connected to the associated source input terminals, the first ends being closer to the plurality of the source input terminals than second ends away from the source input terminals of the source lines connected to the associated source input terminals,
wherein the display panel further includes second switches connected between the common electrodes and the second ends of the source lines connected to the associated source input terminals,
wherein the second switches are configured to electrically disconnect the source lines connected to the associated source input terminals from the common electrodes in the display drive operation, and
wherein the second switches electrically connects the source lines connected to the associated source input terminals to the common electrodes in the capacitive sensing operation.

10. The display device according to claim 8, further comprising a common voltage generator circuitry configured to generate a common voltage,
wherein the display panel further includes:
a common voltage input terminal receiving the common voltage from the common voltage generator circuitry; and
third switches respectively connected between the common voltage input terminal and the plurality of common electrodes,
wherein the third switches electrically connect the plurality of common electrodes to the common voltage input terminal in the display drive operation, and
wherein the third switches electrically disconnect the plurality of common electrodes from the common voltage input terminal in the capacitive sensing operation.

11. The display device according to claim 8, wherein each of the source input terminals is associated with a plurality of associated source lines out of the plurality of source lines,
wherein the display panel further includes a plurality of fourth switches connected between each of the source input terminals and the plurality of associated source lines associated with each of the source input terminals, and
wherein the plurality of fourth switches connected between each of the source input terminals and the plurality of associated source lines are time-divisionally turned on in the display drive operation.

12. The display device according to claim 8, wherein the plurality of common electrodes is arrayed in a plurality of rows and a plurality of columns.

13. The display device according to claim 12, wherein the display panel further includes a plurality of connection lines extended in a direction in which the source lines are extended,
wherein each of the common electrodes is connected to at least one of the plurality of connection lines so that each of the plurality of connection lines is connected to a single one of the common electrodes, and
wherein the first switch connected between each of the common electrodes and the at least one associated source input terminal is connected between one of the connection lines connected to each of the common electrodes and the at least one of the associated source input terminal.

14. The display device according to claim 13, wherein the display driver further includes a common voltage generator circuitry configured to generate a common voltage,
wherein the display panel further includes:
a common voltage input terminal configured to receive the common voltage from the common voltage generator circuitry; and
third switches respectively connected between the common voltage input terminal and the plurality of connection lines,
wherein the third switches are configured to electrically connect the plurality of common electrodes to the common voltage input terminal in the display drive operation, and
wherein the third switches are configured to electrically disconnect the plurality of common electrodes from the common voltage input terminal in the capacitive sensing operation.

15. The display device according to claim 13, wherein each of the plurality of source input terminals is associated with a plurality of associated source lines of the plurality of source lines,
wherein the display panel further includes a plurality of fourth switches connected between each of the plurality of source input terminals and the associated source lines associated with each of the plurality of source input terminals, and
wherein the plurality of fourth switches connected between each of the source input terminals and the plurality of associated source lines are time-divisionally turned on in the display drive operation.

16. A display panel, comprising:
a plurality of source lines;
a plurality of source input terminals configured to receive source signals to be supplied to the plurality of source lines from a display driver;
a plurality of common electrodes; and
first switches, each of which is connected between each of the plurality of common electrodes and at least one associated source input terminal of the plurality of source input terminals, the at least one associated source input terminal being associated with each of the plurality of common electrodes.

17. The display panel according to claim 16, wherein the plurality of source lines is connected in a one-to-one relationship to the plurality of source input terminals,
wherein the first switches are connected to first ends of source lines connected to the associated source input terminals, the first ends being closer to the plurality of the source input terminals than second ends away from the source input terminals of the source lines connected to the associated source input terminals, and
wherein the display panel further includes second switches connected between the common electrodes and the second ends of the source lines connected to the associated source input terminals.

18. The display panel according to claim 16, further comprising:
a common voltage input terminal configured to receive the common voltage from the display driver; and
third switches respectively connected between the common voltage input terminal and the plurality of common electrodes.

19. The display panel according to claim 16, wherein each of the source input terminals is associated with a plurality of associated source lines out of the plurality of source lines, and
wherein the display panel further includes a plurality of fourth switches connected between each of the source input terminals and the plurality of associated source lines associated with each of the source input terminals.

20. The display panel according to claim 16, wherein the plurality of common electrodes is arrayed in a plurality of rows and a plurality of columns.

21. The display panel according to claim 20, further comprising a plurality of connection lines extended in a direction in which the source lines are extended,
wherein each of the common electrodes is connected to at least one of the plurality of connection lines so that each of the plurality of connection lines is connected to a single one of the common electrodes, and
wherein the first switch connected between each of the common electrodes and the at least one associated source input terminal is connected between one of the connection lines connected to each of the common electrodes and the at least one of the associated source input terminal.
